(19) United States
(12) Patent Application Publication
(10) Pub. No.: US 2007/0204974 A1
(43) Pub. Date: Sep. 6, 2007

(54) Heat pipe with controlled fluid charge

(76) Inventors: Ramesh Gupta, Berkeley Heights, NJ (US); Walter Weissman, Basking Ridge, NJ (US); George P. Walchuk, Annandale, NJ (US); Randall D. Partridge, Califon, NJ (US)

Correspondence Address: ExxonMobil Research and Engineering Company, P.O. Box 900, Annandale, NJ, 08801-0900, US

(21) Appl. No.: 11/726,687

(22) Filed: Mar. 22, 2007

Related U.S. Application Data
(63) Continuation-in-part of application No. 11/187,682, filed on Jul. 22, 2005.
(60) Provisional application No. 60/785,426, filed on Mar. 24, 2006.

(51) Int. Cl. F28D 15/00; F02G 5/00

(52) U.S. Cl. 165/104.21; 123/557; 165/104.26

(57) ABSTRACT

The present invention is a heat pipe having a specified volume of working fluid determined in relation to the interior volume of the heat pipe and a target temperature T_{T}, to provide self-temperature regulation and pressure management. The heat pipe comprises at least a evaporator region and a condenser region having a known interior volume V and a mass of working fluid given by the relationship
M_{wf}=D_{wf} at T_{T}×V plus an amount of additional working fluid sufficient to have the rate of evaporation about equal to the rate of condensation for the particular heat pipe configuration.

This application claims the benefit of U.S. Provisional Application No. 60/785,426 filed Mar. 24, 2006, and a Continuation-in-Part of U.S. Non-Provisional application Ser. No. 11/187,672 filed Jul. 22, 2005.

### FIELD OF THE INVENTION

The present invention relates generally to heat pipes. More specifically the invention pertains to a heat pipe having a fluid charge particularly specific to provide regulation of temperature and pressure.

### FIELD OF THE INVENTION

Heat pipes are efficient heat transport devices. Their origin likely dates back to the 1940's as evidenced by U.S. Pat. No. 2,350,348. A heat pipe generally comprises a sealed container, such as a pipe with end caps, a wick structure, and an amount of working fluid. FIG. 1 illustrates a conventional heat pipe. Heat applied to the evaporator region by an external heat source vaporizes the working fluid. The vapor pressure of the vaporized working fluid drives the vapor through the adiabatic region to the condenser region where the vapor condenses, releasing its latent heat to the intended heat transfer recipient. The condensed fluid is then transported back through the adiabatic region to the evaporator region via the wick apparatus, via capillary action. The process repeats so long as there is sufficient means to drive the condensed working fluid back to the evaporator region. The use of gravity force to aid or replace the capillary function of the wick apparatus is also well known in the art. Heat pipes that do not use a wick but depend solely on gravity for transporting the condensed fluid are sometimes called thermal siphons.

The heat pipe process described above is well known, and is further detailed in Heat Pipe Science and Technology by Amir Faghri and published by Taylor & Francis Publishers (1995).

Conventionally, the “working fluid” is selected based upon the temperature range of intended application. The art generally recognizes that the useful temperature range for a given working fluid ranges generally from the temperature at which the working fluid exhibits a saturation pressure greater than 0.1 Atm, up to about 20 Atm. This generally allows containment of the fluid and its vapor without excessive pressure in the heat pipe container. For example, water exhibits a useful working fluid temperature range from about 300° K to about 500° K. A table of conventional working fluids and their suitable temperature ranges may be found in Heat Pipe Science and Technology, Amir Faghri, Taylor & Francis (1995) which is hereby incorporated by reference

Conventional heat pipes contain an ample charge of the working fluid so that the liquid never fully vaporizes in the temperature range in which the heat pipe is intended for operation. In contrast, the heat pipe of the present invention contains a specified volume of working fluid that results in at least three advantages, self-regulation of temperature, pressure management, and enhanced safety.

### SUMMARY OF THE INVENTION

The present invention pertains to a heat pipe having a specified mass of working fluid determined in relation to the interior volume of the heat pipe, a target temperature, and the thermal design characteristics and the specific configuration of the heat pipe to provide automatic temperature regulation and pressure management.

### BRIEF DESCRIPTION OF THE DRAWINGS

FIG. 1 is a cross sectioned illustration of a conventional heat pipe.

FIG. 2 is a cross sectioned illustration of an embodiment of the heat pipe of the present invention.

FIG. 3 is a graph of Temperature versus Pressure for the heat pipe of the present invention.

FIG. 4 is a cross sectioned illustration of an embodiment of the heat pipe of the present invention.

FIG. 5 is a graph of Temperature versus Position for the heat pipe of the present invention.

### DETAILED DESCRIPTION OF THE INVENTION

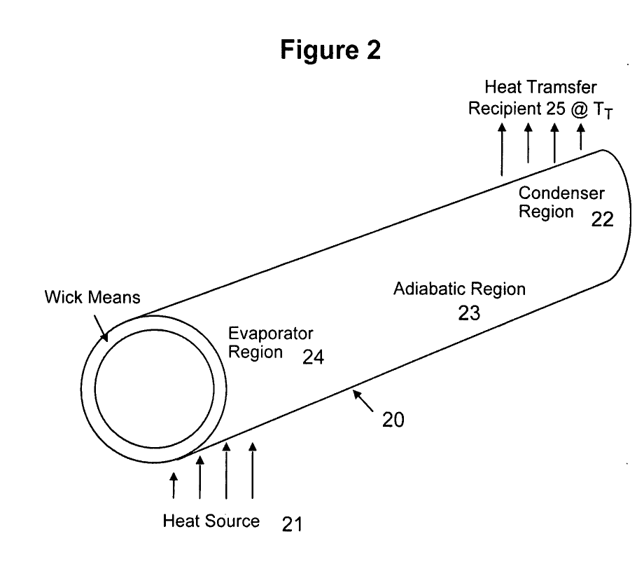

The present invention may be understood by reference to the heat pipe configuration illustrated in FIG. 2.

The volume of the heat pipe (interior) is determined by conventional means, and is here referred to as V. The user then identifies a target temperature T_{T} that is intended to be the self-regulating temperature of the object(s) being heated by the heat pipe, and selects a working fluid that is known to be operable in the temperature range of interest.

Referring to FIG. 2, heat pipe (20) has a known interior volume V, which includes all interior volumes for the condenser region (22), adiabatic region (23) and evaporator region (24). Heat source (21) supplies heat to the evaporator region at or above T_{T}. The condenser region (22) transfers heat to the intended recipient (25) at about T_{T}. The total fluid charged to the heat pipe for self regulation of temperature T_{T} is determined as follows:

A. A no heat load mass is calculated as M_{wf}=D_{wf}@T_{T}×V where M_{wf} is the mass of the working fluid, D is the density at T_{T}; and

B. An additional amount of working fluid is added such that the following conditions are met:
1. The rate of evaporation and/or boil off of the total working fluid at T_{T} is about equal to the rate of condensation of the working fluid at T_{T}.
2. The rate of supply of condensate to the evaporator region is about equal to the rate of evaporation and/or boil off of working fluid.
   Conditions 1 and 2 can be empirically determined for a given heat pipe configuration, or established by fluid dynamic flow relationship available to the skilled artisan

An additional condition may be satisfied for determining the total working fluid mass of the present invention. At a condition of maximum heat load to the condenser, a gas bubble (as defined hereinafter) of superheated gas of the working fluid, initiates in the evaporator region

Description of Heat Pipe Operation

In a heat pipe, heat is transferred from a heat source to the heat transfer recipient. This is achieved by evaporating and boiling the working fluid in the evaporator region using heat from the heat source. The vapors generated by boiling are driven to the condenser region where the vapors condense and transfer their latent heat to the heat recipient. The condensate flows back to the evaporator region where they boil-off again, thus providing continuous transfer of heat from the evaporator region to the condenser region.

Referring to FIG. 2, a feature of the current invention is that the heat transfer from the heat source (21) to boil-off the fluid in evaporator (24) adjusts automatically and passively to match the heat demand by the heat recipient (25) to maintain the heat recipient (25) temperature at approximately T_{T} and the temperature of the condenser region at about T_{Tc}. T_{Tc} is approximately equal to T_{T}, where the difference is attributable to heat transfer loss between the condenser region (22) and the heat recipient (25). This temperature regulation is achieved by limiting the fluid charge to the heat pipe such that at least a portion of the evaporator region dries out when the evaporator region exceeds T_{T}. Since no evaporation and boiling can take place in the dry portion of the evaporator region, the total boiling rate is also limited. Essentially, a gas bubble is formed initiating in the lowest most section of the evaporator region (24) impeding heat transfer from the heat source (21) to the heat pipe. The term “gas bubble” as used herein, means a region within the heat pipe occupied by superheated gas of the working fluid (i.e. no liquid state) initiated in the evaporator region, typically at its lowest most level. The size of the dry gas bubble, by expanding or contracting, passively adjusts itself such that the heat transfer from the heat source to the heat pipe is about equal to the heat demand of the heat recipient, thereby maintaining at the condenser region at approximately TTC and the heat recipient at T_{T}.

In any specific heat pipe application of the present invention, the heat demand of the heat recipient (25) may vary over a range. For example, the heat recipient may be a hydrocarbon process flow stream which needs to be maintained at a temperature of about T_{T}. The heat demand to maintain its temperature at about T_{T} will vary as the flow rate of this stream varies. Likewise, the temperature of the heat source may also vary in a range above about T_{T}.

The quantity of the fluid charge in the heat pipe of the present invention is such that the gas bubble size adjusts in response to the varying heat demand and the heat source temperature, such that a near constant temperature T_{T} is achieved at the heat recipient.

For example, when the heat source temperature is just above T_{T} and there is heat demand by the heat recipient (25), only a very small gas bubble forms in the lower end of the evaporator region (24). The evaporator is essentially unimpeded and can accept the necessary amount of heat from the heat source (21) and transmit this heat to the working fluid to meet the heat demand of the heat recipient (25).

When the heat demand by the heat recipient drops, the amount of condensate that is returned to the evaporator region will also drop. This will cause the gas bubble initiated in the evaporator section to expand and impede the transfer of heat to the working fluid. The less the heat demand by the heat recipient the less condensate will be returned to the evaporator and increase the size of the bubble. The heat transfer from the heat source to the working fluid will be adequately impeded by the gas bubble to equal the heat demand by the heat recipient at temperature T_{T}.

The same principle of impeding the heat transfer to the working fluid by a self adjusting gas bubble applies when the heat source (21) temperature fluctuates substantially above T_{T}. The gas bubble will expand to adequately impede heat transfer to the evaporator section so as not to overheat the heat recipient above T_{T}. If concurrently the heat demand by the heat recipient goes down, the condensate return will be reduced further and the bubble will further expand to further impede heat transfer to the evaporator.

The following table provides a summary of how the gas bubble adjusts in size so that the heat transfer to the working fluid approximately equals the heat demand by the heat recipient to maintain its temperature at approximately T_{T}.

TABLE 1

| | | | Characteristics of the |
|---|---|---|---|
| | Operating | Bubble Size and Heat | Condensate Returning to |
| | Conditions | Transfer Characteristics | the Evaporator |
| (A) | High heat | Near zero bubble size. Heat | High rate of condensate |
| | demand, low | transfer to working fluid | return. Liquid and vapor |
| | heat source | from heat source | coexist in full length of the |
| | temperature | essentially unimpeded. | evaporator. |
| (B) | Low heat | Gas bubble expands | Low heat demand leads to |
| | demand, low | relative to (A) to | low rate of condensate |
| | heat source | adequately impede heat | return. Condensate available |
| | temperature | transfer to working fluid to | only in the condenser section |
| | | match heat demand. | where bubble is not present. |
| (C) | High heat | Gas bubble expands | High heat demand leads to |
| | demand, high | relative to (A) to impede | high rate of condensate |
| | heat source | heat transfer from the heat | return. The returning |
| | temperature | source to the working fluid. | condensate fully evaporates |
| | | | before reaching the far end |
| | | | of the evaporator due to the |
| | | | high heat source temperature. |
| (D) | Low heat | Bubble expands further | Low heat demand and low |
| | demand, high | beyond case (C), | rate of condensate return. |
| | heat source | increasing impedance to | Large bubble provides |
| | temperature. | heat transfer from the very | significant impedance to heat |
| | | hot heat source. | transfer from the very hot |
| | | | heat source to the working |
| | | | fluid. |

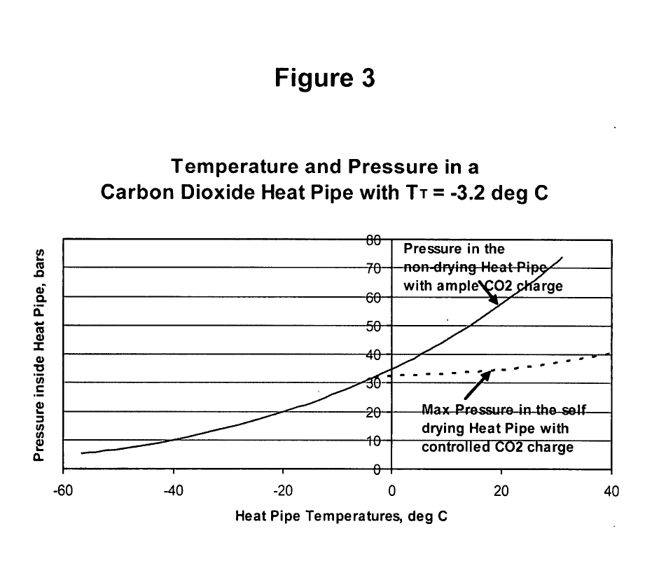

In addition to self-regulation of temperature, the heat pipe of the present invention provides effective pressure management. In a conventional heat pipe with an ample fluid charge, the vapor and liquid are essentially at boiling equilibrium and the pressure is essentially the vapor pressure of the fluid. Since the vapor pressure generally increases almost exponentially with temperature, the pressure inside the conventional heat pipe increases super linearly when heat is supplied from the heat source to increase the heat pipe temperature. In contrast, pressure in the present invention increases exponentially or super linearly only till the temperature T_{T} is achieved in the evaporator region of the heat pipe. Above T_{T}, there is substantially no liquid and the vapor in the evaporator region is below its vapor pressure. Since the pressure of super heated vapor bubble will generally increase about linearly with the absolute temperature and not increase exponentially, the pressure rise in the heat pipe can be more easily managed. Essentially, the pressure buildup is moderated above temperature T_{T} because liquid is not available to generate additional vapors. This temperature pressure relationship is graphically illustrated in FIG. 3 for a heat pipe using a controlled carbon dioxide charge to regulate the temperature at −3.2° C.

The following exemplifies specific embodiments of the present invention.

### EXAMPLE 1

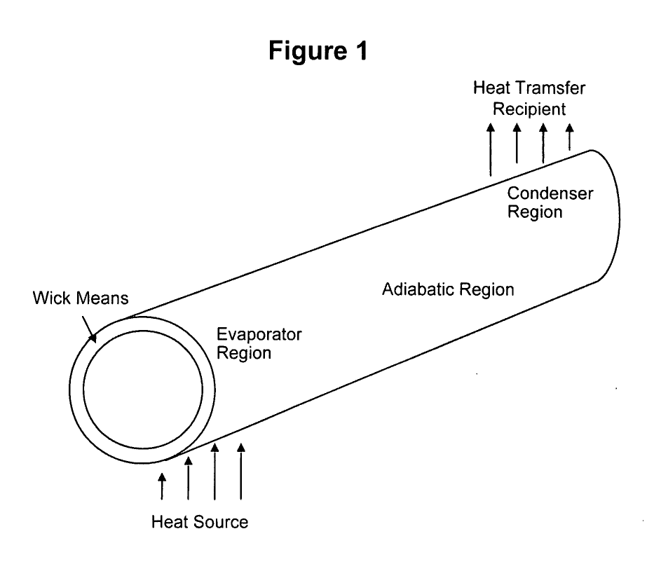

A design analysis was done for a heat pipe configured as illustrated in FIG. 1, having a diameter of 2 cm and a length of 50 cm and an internal volume of 157.08 cc. In this example, the heat pipe is used to transport heat from a variable temperature heat source to a target body at T_{T}=−3.2° C. Carbon dioxide is used as a working fluid. The mass of the working fluid was determined as discussed previously. The fluid mass consisted of first calculating the carbon dioxide mass required to fill the heat pipe volume with saturated carbon dioxide vapors at T_{T}=−3.2° C. and then adding additional carbon dioxide to account for the liquid condensate that would exist in the adiabatic and condenser regions of the heat pipe. The density of saturated CO₂ vapor at −3.2° C. is 0.0885 g/cc. Accordingly, 13.9 grams of CO₂ is charged to the heat pipe to fill it with saturated vapors at −3.2 degree C. and the additional carbon dioxide required to account for liquid carbon dioxide in the adiabatic and condenser sections was empirically determined as previously described. The heat pipe so configured is operated with heat source (21) whose temperature may vary in a temperature range above −3.2° C. The heat pipe self-regulates at T_{T} equal to about −3.2° C.

FIG. 3 is an illustration of the temperature and pressure inside the above heat pipe designed to regulate the temperature at −3.2° C. Below −3.2° C., carbon dioxide is present as a combination of liquid and vapor. As the temperature of the heat pipe is raised to about −3.2° C. by using heat from the heat source, the liquid carbon dioxide in the evaporator section vaporizes. The heat pipe will regulate its temperature at about −3.2° C. and its temperature will not generally increase above about −3.2° C. Below −3.2° C., the vapor and liquid are essentially in boiling equilibrium and the pressure inside the heat pipe is essentially the saturation vapor pressure of carbon dioxide at the heat pipe temperature. This saturation vapor pressure increases super linearly as is shown in FIG. 3. Had the heat pipe been designed with excessive carbon dioxide, the pressure would have kept on increasing super linearly.

However, with the controlled charge, there is no liquid carbon dioxide inside the evaporator region of the heat pipe at temperature exceeding about −3.2° C. Even if the heat pipe heats up above −3.2° C. due to some extraneous heat, the pressure will increase only modestly, and only linearly with absolute temperature. This modest increase in pressure due to hypothetical extraneous heat is shown by the broken line in FIG. 3. Thus, the pressure in the heat pipe is also managed and regulated.

### EXAMPLE 2

In a second example of the present invention, heat was extracted from a hot gas stream whose temperature varied over a large range from 300 to 600° C. It was desired to heat a hydrocarbon stream using this heat. In this case the temperature of the hydrocarbon stream was regulated at about 240° C.

A heat pipe with an internal volume of 251 cc was built. A finned heat exchanger was used to transfer heat from a hot gas stream to the evaporator section of the heat pipe. Similarly, a condenser was built to transfer heat to a hydrocarbon stream with the aim of heating the hydrocarbon stream to a regulated temperature of about 240° C. Water was selected as the working fluid for this heat pipe application. The heat pipe was evacuated of all gases and then first charged with about 4.1 grams of water. This 4.1 grams of water was calculated by multiplying the heat pipe volume (=251 cc) by the density of saturated water vapor (steam) at 240° C. (=0.016 g/cc). An additional amount of water was added to compensate for the shuttling-water between the evaporator and the condenser, and the water retained inside the wick as described earlier. This heat pipe, using a controlled-fluid charge was then found to regulate the temperature of the hydrocarbon stream at about 240° C. when the temperature of the hot gas stream varied over the large range mentioned above. Thus, by using a prescribed quantity of fluid charge a substantially constant temperature of the hydrocarbon stream was obtained.

### EXAMPLE 3

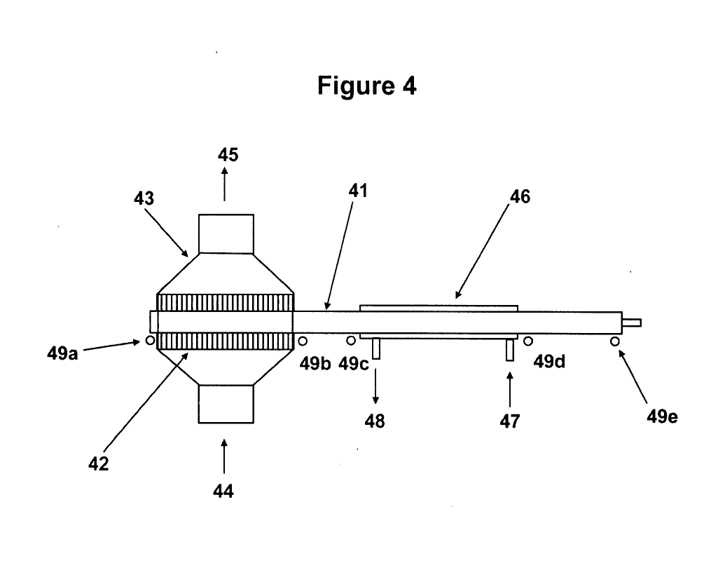

FIG. 4 illustrates a heat pipe fabricated to demonstrate the invention. The heat pipe tube (41) has an internal volume of 193 cc. The finned heat exchanger (42) with an effective area of 0.32 m2, was used to transfer heat from a hot gas stream (44) supplied at the evaporator end of the heat pipe by means of the ducted enclosure (43). A condenser heat exchanger (46) was used to transfer heat to a gasoline fuel stream (47) with the heated fuel exiting as stream (48). Temperatures were measured by means of thermocouples in the entering and exiting fluid steams (44,45,46,47) and along the length of the heat pipe (49a-e).

The evacuated heat pipe tube described was charged with 3 g of distilled water and 0.05 g of Argon. This amount of water was chosen to maintain operating temperatures of <200° C. with variable heat inputs and fuel loads. The corresponding steam density at 200° C. is 0.0076 g/cc. This 3 g of water provides both the saturated water vapor to fill the heat pipe tube volume of 193 cc and also provides adequate liquid water condensate circulation.

The heat pipe was mounted at a variety of tube angles from 5 to 45 degrees for testing, with the heated evaporator section at the low position. The heat pipe tube and fuel heat exchanger were insulated.

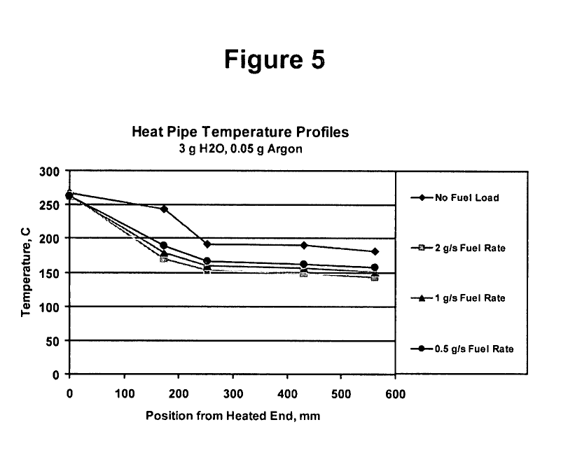

The heat pipe described by FIG. 4 was evaluated at an angle of 10 degrees to heat gasoline fuel flowing at 0.5 to 2 g/s and 450 kPa pressure. One test was conducted with no fuel flowing. The results are shown in FIG. 5.

Hot nitrogen flowing at about 7.8 g/s and 375° C. was used as the heat source to heat the gasoline to a nearly constant temperature of approximately 160° C., with a variation of less than 10° C. with the fuel flow varying from 0.5 to 2 g/s.

Temperatures along the length of the heat pipe tube were measured at positions noted in FIG. 4. Temperatures at the condensate end of the heat pipe remained nearly constant with varied fuel load as shown in FIG. 5. Temperatures measured at the evaporator were higher indicating the presence of superheated gas bubble.

With no fuel load temperatures increased slightly, but remained less than 200° C. with the minimal load resulting from heat losses along the length of the heat pipe. The result suggests that fuel rates lower than 0.5 g/s can be used.

What is claimed is:

1. A heat pipe for providing heat transfer to a heat recipient at a temperature of about T_{T} comprising at least a evaporator region and a condenser region having a known interior volume V and a determined mass of working fluid at least equal to M_{wf}, whereby the mass of working fluid is determined by the relationship
M_{wf}=D_{wf} at T_{T}×V

2. The heat pipe of claim 1 wherein the working fluid comprises M_{wf} plus an additional amount of fluid that, at the temperature of about T_{T},
a. evaporation from the evaporator region is about equal to condensation, and
b. rate of supply of condensate to the evaporation region is about equal to rate of evaporation from the evaporation region.

3. The heat pipe of claim 2 wherein the mass of working fluid is further characterized as an amount sufficient, at about T_{T}, for initiating a gas bubble in the evaporation region when heat is transferred to the heat recipient.

4. The heat pipe of claim 3 wherein the mass of the working fluid ranges from about M_{wf} to about 150% M_{wf}.

5. The heat pipe of claim 4 wherein the mass of the working fluid ranges from about M_{wf} to about 125% M_{wf}.

6. A method for controlling temperature T_{T} of heat transfer in a heat pipe having at least an evaporation region and a condenser region, from a heat source to a heat recipient, comprising:
a. determining interior volume of the heat pipe,
b. selecting a working fluid for the heat pipe having a known density D_{wf},
c. determining a mass of working fluid according to the relationship
M_{wf}=D_{wf} at T_{T}×V,
d. supplying at least the mass of working fluid of step c to the heat pipe.

7. The method of claim 6 wherein a sufficient amount of working fluid is added to initiate a gas bubble in the evaporation region whenever the temperature of the evaporation zone is above about T_{T}.

8. The method of claim 7 wherein the mass of the working fluid ranges from, abut M_{wf} to about 150% M_{wf}.

9. The method of claim 8 wherein the mass of the working fluid ranges from about M_{wf} to about 125% M_{wf}.
